(19) United States
(12) Patent Application Publication
(10) Pub. No.: US 2019/0252931 A1
(43) Pub. Date: Aug. 15, 2019

(54) ROTARY ELECTRICAL MACHINE

(71) Applicant: DENSO CORPORATION, Kariya-city, Aichi-pref. (JP)

(72) Inventor: Yuuki TAKAHASHI, Kariya-city (JP)

(73) Assignee: DENSO CORPORATION, Kariya-city, Aichi-pref. (JP)

(21) Appl. No.: 16/333,966

(22) PCT Filed: Sep. 13, 2017
(86) PCT No.: PCT/JP2017/033091

§ 371 Date: Mar. 15, 2019

(30) Foreign Application Priority Data
Sep. 15, 2016 (JP) 2016-180992

(51) Int. Cl. H02K 1/22; H02K 3/42; H02K 21/04

(52) U.S. Cl. CPC H02K 1/226; H02K 21/044; H02K 3/42

(57) ABSTRACT

In a rotary electrical machine, a rotor has a field core, a field winding, and a cylindrical short-circuit member. The field core has a cylindrical boss part and a plurality of magnetic pole parts that are disposed on the outer peripheral side of the boss part and in which magnetic poles of different polarities are alternately formed in the circumferential direction. The field winding is wound on the outer peripheral side of the boss part. The short-circuit member is disposed on the outer peripheral sides of the magnetic pole parts and magnetically connects together the magnetic pole parts adjacent to each other in the circumferential direction. A surface of the short-circuit member opposed to the stator is formed in a concave-convex shape in which protrusion portions protruding along the radial direction and groove portions recessed along the radial direction are disposed alternately and continuously with each other.

### TECHNICAL FIELD

The present disclosure relates to a rotary electrical machine.

### BACKGROUND ART

There has been conventionally known a rotary electrical machine including a stator and a rotor for use in vehicle electric motors and power generators, and others (for example, refer to PTL 1 and others). In this rotary electrical machine, the stator has a stator core and an armature winding wound on the stator core. The rotor has a field core, a field winding, and a short-circuit member.

The field core has a boss part, a disc part, and magnetic pole parts. The disc part is radially widened at an axial end of the boss part. The magnetic pole parts are connected to the disc part and disposed on an outer peripheral side of the boss part, and protrude along the axial direction. The plurality of magnetic pole parts are provided at predetermined angles such that magnetic poles of different polarities are alternately formed in a circumferential direction. The field winding is wound on the outer peripheral side of the boss part. The short-circuit member is disposed on the outer peripheral sides of the magnetic pole parts to cover the outer peripheral surfaces of the magnetic pole parts and magnetically connects together the magnetic pole parts adjacent in the circumferential direction. The short-circuit member is a stacked member in which a plurality of soft magnetic sheets are stacked along the axial direction. Therefore, according to the structure of the short-circuit member, it is possible to reduce eddy-current loss generated in the short-circuit member.

### CITATION LIST

### Patent Literature

[PTL 1] JP 2009-148057 A

### SUMMARY OF THE INVENTION

### Technical Problem

To improve the effect of reducing eddy-current loss generated in the short-circuit member, it is conceivable to provide an electrical insulating layer between the layers, that is, between the soft magnetic sheets. However, in the structure with the electrical insulating layers, there occurs a problem that it is not possible to increase the effect of reducing eddy-current loss in the event of an insulation breakdown in the electrical insulating layer.

The present disclosure is to provide a rotary electrical machine that improves the effect of reducing eddy-current loss generated in the short-circuit member.

### Solution to Problem

A rotary electrical machine as an aspect of the technique of the present disclosure includes a stator and a rotor. The stator has a stator core and an armature winding wound on the stator core. The rotor has a field core, a field winding, and a cylindrical short-circuit member, and is radially opposed to an inner peripheral side of the stator. The field core has a cylindrical boss part and a plurality of magnetic pole parts that are disposed on an outer peripheral side of the boss part and in which magnetic poles of different polarities are alternately formed in the circumferential direction. The field winding is wound on the outer peripheral side of the boss part. The short-circuit member is disposed on the outer peripheral sides of the magnetic pole parts to cover the outer peripheral surfaces of the magnetic pole parts and magnetically connects together the magnetic pole parts adjacent to each other in the circumferential direction. A surface of the short-circuit member opposed to the stator is formed in a concave-convex shape in which protrusion portions protruding along the radial direction and groove portions recessed along the radial direction are disposed alternately and continuously with each other.

According to this configuration, in the rotary electrical machine of the present disclosure, the surface of the short-circuit member opposed to the stator is formed in the concave-convex shape in which the protrusion portions and the groove portions are disposed alternately and continuously in the radial direction. In the rotary electrical machine, the concave-convex shape of the short-circuit member concentrates magnetic flux on the protrusion portions to prevent other portions from magnetic flux saturation. Accordingly, in the rotary electrical machine, the magnetic flux density decreases to reduce eddy-current loss. Therefore, in the rotary electrical machine, forming the surface of the short-circuit member in the concave-convex shape improves the effect of reducing eddy-current loss.

In the rotary electrical machine of the present disclosure, each of the protrusion portions is formed such that the cross section of a radial tip has a curved shape or an angular shape. According to this configuration, the rotary electrical machine of the present disclosure can form the concave-convex shape on the surface of the short-circuit member.

In the rotary electrical machine of the present disclosure, each of the protrusion portions is formed such that the cross section of the radial tip has a trapezoidal shape in which an upper tip face of a short side is positioned on the stator side and a lower tip face of a long side is positioned on the magnetic pole part side. According to this configuration, the rotary electrical machine of the present disclosure can form the concave-convex shape on the surface of the short-circuit member.

In the rotary electrical machine of the present disclosure, the short-circuit member and the magnetic pole parts are electrically continuous with each other. According to this configuration, even in the event of large eddy current in the short-circuit member, the rotary electrical machine of the present disclosure can raise the electrical potential of the rotor by the eddy current. Accordingly, the rotary electrical machine can reduce current conducted from the stator to the rotor via a bearing that would be caused by a difference in timing for switching to supply electric power to the armature winding. The rotary electrical machine can suppress reduction of the life of the bearing caused by electrolytic corrosion.

In the rotary electrical machine of the present disclosure, a resin is charged in at least one of a clearance between the short-circuit member and the magnetic pole parts and the groove portions. According to this configuration, the rotary electrical machine of the present disclosure can improve heat capacity by the provision of the resin as a heat conductor. Accordingly, the rotary electrical machine can improve the heat-resistance property of the rotor. The rotary electrical machine can also sufficiently enhance the cooling performance of the rotor even when the rotor does not rotate or the rotor rotates at a low speed.

In the rotary electrical machine of the present disclosure, the protrusion portions and the groove portions are formed in a spiral shape and extended along the axial direction. According to this configuration, the rotary electrical machine of the present disclosure can feed a coolant from the first axial end side to the second axial end side of the short-circuit member during rotation of the rotor. Accordingly, the rotary electrical machine can efficiently cool the rotor by the flow of the coolant to enhance the cooling performance of the rotor.

In the rotary electrical machine of the present disclosure, the short-circuit member is a stacked member in which predetermined members are stacked along the axial direction. According to this configuration, the rotary electrical machine of the present disclosure allows easy formation of the concave-convex shape on the surface of the short-circuit member.

### BRIEF DESCRIPTION OF THE DRAWINGS

FIG. 1 is a cross-sectional view of a rotary electrical machine according to a first embodiment;

FIG. 2 is a diagram of a rotor of the rotary electrical machine in the first embodiment as seen from a radially outer side;

FIG. 3 is a perspective view of the rotor of the rotary electrical machine in the first embodiment;

FIG. 4 is a perspective view of the rotor without a short-circuit member in the first embodiment;

FIG. 5 is a partial perspective view of the rotor of the rotary electrical machine in the first embodiment;

FIG. 6 is a cross-sectional view of the rotor of the rotary electrical machine in the first embodiment;

FIG. 7 is a schematic cross-sectional view of the short-circuit member in the rotor of the rotary electrical machine in the first embodiment;

FIG. 8 is a cross-sectional view of an example of the short-circuit member in the rotary electrical machine in the first embodiment;

FIG. 9 is a cross-sectional view of an example of the short-circuit member in the rotary electrical machine in the first embodiment;

FIG. 10 is a cross-sectional view of an example of the short-circuit member in the rotary electrical machine in the first embodiment;

FIG. 11 is a cross-sectional view of an example of the short-circuit member in the rotary electrical machine in the first embodiment;

FIG. 12 is a cross-sectional view of an example of the short-circuit member in the rotary electrical machine in the first embodiment;

FIG. 13 is a perspective view of a short-circuit member in a rotor of a rotary electrical machine according to a modification example;

FIG. 14 is a cross-sectional view of an example of main components in a rotor of a rotary electrical machine according to another modification example; and

FIG. 15 is a cross-sectional view of an example of main components in a rotor of a rotary electrical machine according to another modification example.

### DESCRIPTION OF EMBODIMENTS

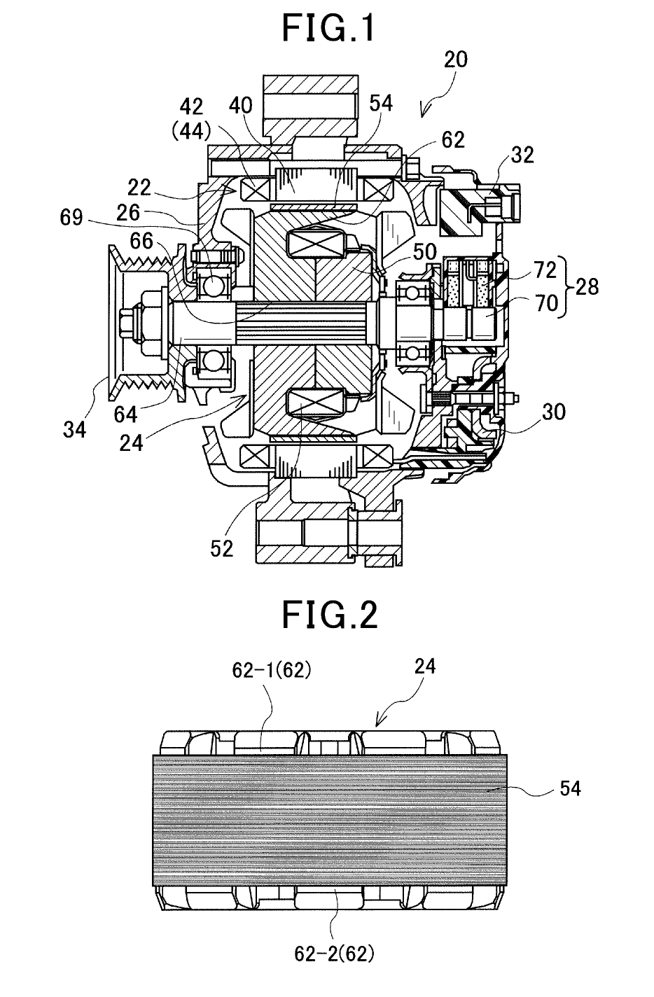

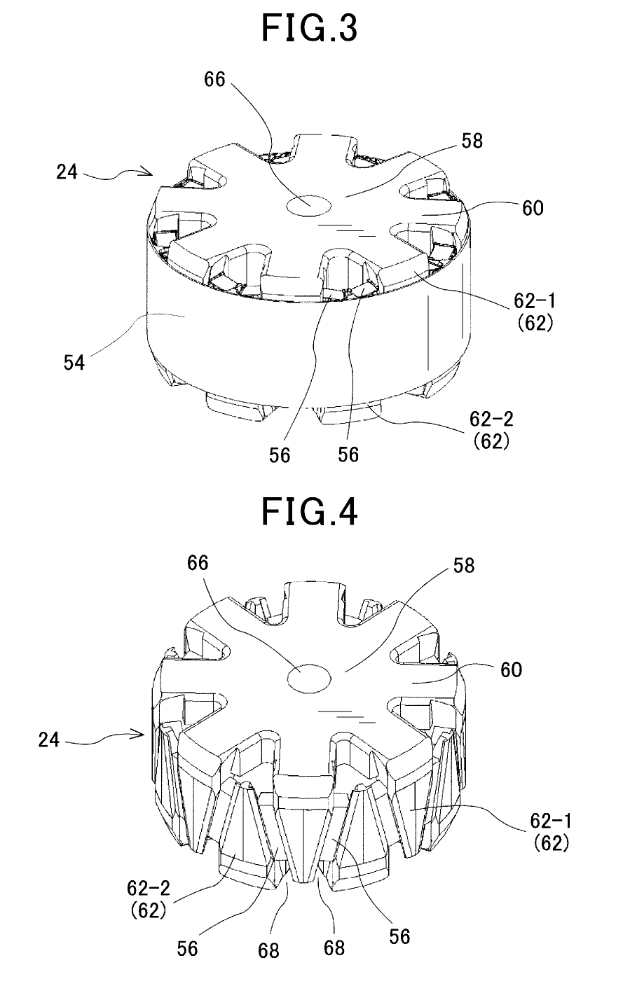

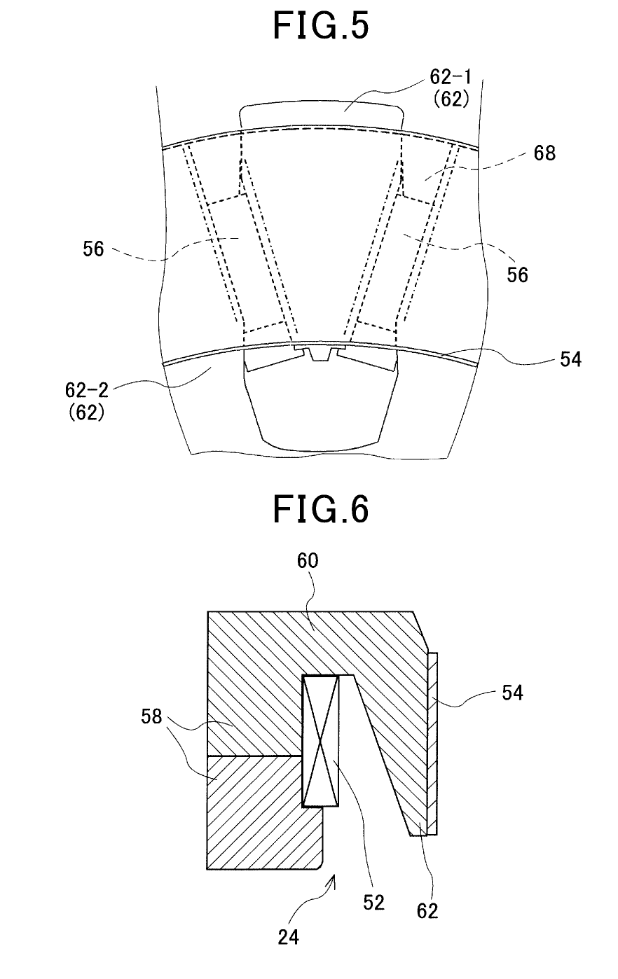

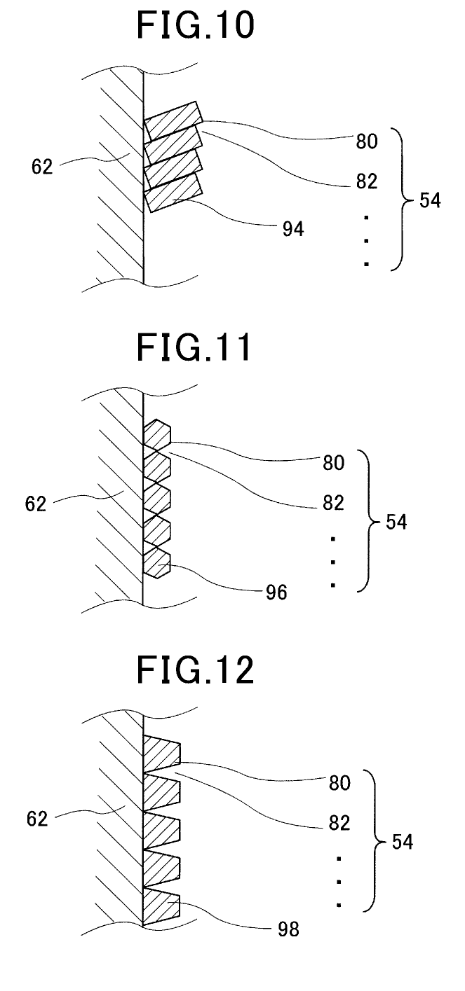

Specific embodiments of a rotary electrical machine as an aspect of the technique of the present disclosure will be described below with reference to FIGS. 1 to 15.

### First Embodiment

In the present embodiment, a rotary electrical machine 20 is mounted in a vehicle or the like, for example. The rotary electrical machine 20 is supplied with electric power from a power source such as a battery to generate drive force for driving the vehicle. The rotary electrical machine 20 is supplied with motive power from the engine of the vehicle to generate electric power for charging the battery. As illustrated in FIG. 1, the rotary electrical machine 20 includes a stator 22, a rotor 24, a housing 26, a brush device 28, a rectifier 30, a voltage adjuster 32, and a pulley 34.

The stator 22 is a member that constitutes part of a magnetic path and is given a rotating magnetic field by the rotation of the rotor 24 to generate electromotive force. The stator 22 has a stator core 40 and an armature winding 42. The stator core 40 is a cylindrical member. The stator core 40 has teeth and slots on its radially inner side. The teeth protrude toward the radially inner side of the stator core 40. The slots are recessed toward the radially outer side of the stator core 40. The pluralities of teeth and slots are disposed at each predetermined angle and are disposed alternately and continuously in a circumferential direction.

The armature winding 42 is wound on the stator core 40 (the teeth of the stator core 40). The armature winding 42 has a linear slot storage portion (not illustrated) and a curved coil end portion 44. The slot storage portion is stored in the slot of the stator core 40. The coil end portion 44 protrudes from the axial end side to the axial outer side of the stator core 40. The armature winding 42 has a multi-phase winding (for example, three-phase winding) corresponding to the number of phases of the rotary electrical machine 20.

The rotor 24 is opposed to the stator 22 (the tips of the teeth of the stator core 40) with a predetermined air gap (that is, void space) therebetween on the radially inner side. The rotor 24 is a member that constitutes part of a magnetic path and forms magnetic poles by the flow of electric current. The rotor 24 is a Lundell-type rotor. The rotor 24 has a field core 50, a field winding 52, a short-circuit member 54, and permanent magnets 56.

The field core 50 has a boss part 58, a disc part 60, and claw-shaped magnetic pole parts 62. The boss part 58 is a cylindrical member with a shaft hole 66. The shaft hole 66 is opened on the central axis such that a rotation shaft 64 is insertable thereinto. The boss part 58 is a portion fitted and fixed to the outer peripheral side of the rotation shaft 64. The disc part 60 is a disc-shaped portion that extends from the axial end portion side of the boss part 58 to the radially outer side.

The claw-shaped magnetic pole parts 62 connect to the outer peripheral end of the disc part 60. The claw-shaped magnetic pole parts 62 are members that protrude from the connection portion in a claw shape along the axial direction. The claw-shaped magnetic pole parts 62 are disposed on the outer peripheral side of the boss part 58. The boss part 58, the disc part 60, and the claw-shaped magnetic pole parts 62 form a pole core (field core). The pole core is formed by forging, for example. Each of the claw-shaped magnetic pole parts 62 has an approximately arc-shaped outer peripheral surface. The outer peripheral surface of each of the claw-shaped magnetic pole parts 62 has an arc centered on the vicinity of the axial center of the rotation shaft 64. Specifically, the outer peripheral surface of each of the claw-shaped magnetic pole parts 62 has an arc centered on the position of the axial center of the rotation shaft 64 or the position of the rotation shaft 64 closer to the claw-shaped magnetic pole parts 62 than the axial center.

The claw-shaped magnetic pole parts 62 include first claw-shaped magnetic pole parts 62-1 and second claw-shaped magnetic pole parts 62-2 in which magnetic poles of different polarities (N pole and S pole) are formed. The first claw-shaped magnetic pole parts 62-1 and the second claw-shaped magnetic pole parts 62-2 constitute a pair of pole cores. The same numbers (for example, eight) of the first claw-shaped magnetic pole parts 62-1 and the second claw-shaped magnetic pole parts 62-2 are provided around the shaft of the rotor 24. The first claw-shaped magnetic pole parts 62-1 and the second claw-shaped magnetic pole parts 62-2 are alternately disposed with a clearance space 68 therebetween in the circumferential direction.

The first claw-shaped magnetic pole parts 62-1 connect to the outer peripheral end of the disc part 60 widened from the first axial end side of the boss part 58 to the radially outer side. These portions protrude to the second axial end side. The second claw-shaped magnetic pole parts 62-2 connect to the outer peripheral end of the disc part 60 widened from the second axial end side of the boss part 58 to the radially outer side. These portions protrude to the first axial end side. The first claw-shaped magnetic pole parts 62-1 and the second claw-shaped magnetic pole parts 62-2 are formed in an identical shape except for the layout position and the orientation of axial protrusion. The first claw-shaped magnetic pole parts 62-1 and the second claw-shaped magnetic pole parts 62-2 are alternately disposed in the circumferential direction such that their axial root sides (or their axial tip sides) are axially facing in opposite directions to each other. These portions are magnetized in mutually different polarities.

The claw-shaped magnetic pole parts 62 are formed such that they have a predetermined width as seen in the circumferential direction (circumferential width) and have a predetermined thickness as seen in the radial direction (radial thickness). Each of the claw-shaped magnetic pole parts 62 is formed such that the circumferential width is gradually smaller and the radial thickness is gradually smaller from the root side near the portion connected to the disc part 60 to the axial tip side. That is, each of the claw-shaped magnetic pole parts 62 is formed to be thinner in both the circumferential direction and the radial direction on the axial tip side. Each of the claw-shaped magnetic pole parts 62 is preferably formed to be circumferentially symmetrical about a circumferential center line.

Each of the clearance spaces 68 is provided between the first claw-shaped magnetic pole part 62-1 and the second claw-shaped magnetic pole part 62-2 adjacent in the circumferential direction. The clearance spaces 68 extend obliquely as seen in the axial direction. The clearance spaces 68 incline from the first axial end side to the second axial end side at a predetermined angle with respect to the rotation shaft of the rotor 24. All the clearance spaces 68 are the same in shape. Each of the clearance spaces 68 is set such that its circumferential size (dimension) hardly changes according to the axial position. That is, each of the clearance spaces 68 is set such that its circumferential dimension is constant or is kept within a very narrow range including the constant value. That is, the first claw-shaped magnetic pole parts 62-1 and the second claw-shaped magnetic pole parts 62-2 are formed such that each of the clearance spaces 68 has a constant circumferential dimension at any axial position and that all the clearance spaces 68 are formed in the same shape.

In the rotor 24, all the clearance spaces 68 are preferably identical in shape as seen in the circumferential direction to avoid the generation of a magnetic imbalance. However, in the rotor 24 rotating in only one direction in particular, for reduction of iron loss or the like, the claw-shaped magnetic pole parts 62 may be formed in a circumferentially asymmetrical shape about a circumferential center line so that the clearance spaces 68 are not constant in the circumferential dimension between the axial positions.

The claw-shaped magnetic pole parts 62 are generally formed in the circumferentially asymmetrical shape when the rotation occurs in one direction or when the magnetic characteristics in the direction opposite to the rotation direction can be lowered as compared to forward magnetic characteristics, for example. This is based on the technique described below. When the rotation direction is constant, the field effect of the stator 22 changes to be stronger or weaker in the direction in which the field force of the claw-shaped magnetic pole parts 62 acts with the center and its vicinity of the claw-shaped magnetic pole parts 62 as a boundary. Accordingly, half of the claw-shaped magnetic pole parts 62 are separated from the stator 22 with the claw-shaped magnetic pole parts 62 on which a stronger field effect acts as a boundary to increase a magnetic air gap from the stator 22. This lessens magnetic saturation in which eddy current is prone to occur, thereby reducing eddy current significantly. On the other hand, the remaining half of the claw-shaped magnetic pole parts 62 are not separated from the stator 22. This decreases the factor of reduction in magnetic flux caused by air gap increase. In the present embodiment, as described later, magnetic saturation is facilitated near the outer peripheral surface of the rotor 24 to obtain the effect of reducing eddy-current loss. Accordingly, in the present embodiment, the claw-shaped magnetic pole parts 62 do not need to be formed in the asymmetrical shape but are desirably formed in the symmetrical shape.

The field winding 52 is disposed in a radial clearance between the boss part 58 and the claw-shaped magnetic pole parts 62. The field winding 52 is a coil member that generates magnetic flux in the field core 50 by distribution of direct electrical current and generates magnetomotive force by power distribution. The field winding 52 is axially wound on the outer peripheral side of the boss part 58. The magnetic flux generated by the field winding 52 is guided to the claw-shaped magnetic pole parts 62 via the boss part 58 and the disc part 60. That is, the boss part 58 and the disc part 60 form a magnetic path in which the magnetic flux generated by the field winding 52 is guided to the claw-shaped magnetic pole parts 62. The field winding 52 has the function of magnetizing the first claw-shaped magnetic pole parts 62-1 to produce the N pole and magnetizing the second claw-shaped magnetic pole parts 62-2 to produce the S pole by the generated magnetic flux.

The short-circuit member 54 is disposed on the outer peripheral side of the claw-shaped magnetic pole parts 62 (the first claw-shaped magnetic pole parts 62-1 and the second claw-shaped magnetic pole parts 62-2). The short-circuit member 54 is a cylindrical member that covers the outer periphery of the claw-shaped magnetic pole parts 62. The short-circuit member 54 has an axial length that is comparable with a distance from the portion of either of the claw-shaped magnetic pole parts 62 connected to the disc part 60 to the axial tip of the claw-shaped magnetic pole part 62. The short-circuit member 54 is a sheet member that has a predetermined thickness as seen in the radial direction. The predetermined thickness is about 0.6 mm to 1.0 mm with which both the mechanical strength and the magnetic performance of the rotor 24 can be ensured, for example. The short-circuit member 54 is opposed to the outer peripheral surface side of the claw-shaped magnetic pole parts 62 and is in contact with the claw-shaped magnetic pole parts 62. The short-circuit member 54 closes the clearance spaces 68 on the radially outer side of the clearance spaces 68 between the first claw-shaped magnetic pole parts 62-1 and the second claw-shaped magnetic pole parts 62-2 adjacent in the circumferential direction. Accordingly, the short-circuit member 54 magnetically connects together the claw-shaped magnetic pole parts 62 (the claw-shaped magnetic pole parts 62-1 and 62-2) adjacent in the circumferential direction.

The short-circuit member 54 may be a non-magnetic body. However, the non-magnetic body would increase the magnetic air gap between the stator 22 and the rotor 24. Accordingly, the short-circuit member 54 is preferably a magnetic body so as not to cause the air gap increase. With its cross section area smaller than the areas of the surfaces of the claw-shaped magnetic pole parts 62 opposed to the stator 22, the short-circuit member 54 can feed effective magnetic force from the rotor 24 to the stator 22.

The short-circuit member 54 is formed from a soft magnetic material such as an electromagnetic steel sheet made of iron or silicon steel, for example. The short-circuit member 54 is a cylindrical pipe-shaped member. Otherwise, the short-circuit member 54 is a stacked member in which predetermined members are stacked along the axial direction. The short-circuit member 54 is fixed to the claw-shaped magnetic pole parts 62 by shrink fitting, press fitting, welding, or a combination of these. When the short-circuit member 54 is a stacked member, the stacking may be made such that a plurality of soft magnetic sheet members such as punched electromagnetic steel sheets are stacked along the axial direction. At this time, each of the sheet members may be subjected to inter-layer insulation from the axially adjacent sheet member to suppress eddy-current loss. Alternatively, the stacking may be made such that one linear member or one belt-like member is extended in a spiral shape and stacked along the axial direction. The linear member or belt-like member may be an angular material with a rectangular cross section or may be formed in a round shape or a curved angular shape from the viewpoint of strength and magnetic performance.

The short-circuit member 54 has the function of smoothing the outer peripheral surface of the rotor 24 and reducing wind noise that would be caused by the concave and convex portions on the outer peripheral surface of the rotor 24. The short-circuit member 54 also has the function of coupling the plurality of claw-shaped magnetic pole parts 62 aligned in the circumferential direction and suppressing the deformation of the claw-shaped magnetic pole parts 62 (radial deformation in particular).

The permanent magnets 56 are stored on the inner peripheral side of the short-circuit member 54. The permanent magnets 56 are inter-magnetic pole magnets that are disposed between the circumferentially adjacent claw-shaped magnetic pole parts 62 (between the first claw-shaped magnetic pole parts 62-1 and the second claw-shaped magnetic pole parts 62-2) to fill the clearance spaces 68. The permanent magnets 56 are disposed in the individual clearance spaces 68, and the permanent magnets 56 are the same in number as the clearance spaces 68. The permanent magnets 56 extend obliquely with respect to the rotation shaft of the rotor 24 according to the shape of the clearance spaces 68. The permanent magnets 56 are formed in a substantially cuboidal shape. The permanent magnets 56 have the function of reducing leakage of magnetic flux between the claw-shaped magnetic pole parts 62 and reinforcing the magnetic flux between the claw-shaped magnetic pole parts 62 and the stator core 40 of the stator 22.

The permanent magnets 56 are disposed such that the magnetic poles are formed in the direction in which to decrease the leakage magnetic flux between the circumferentially adjacent claw-shaped magnetic pole parts 62. The permanent magnets 56 are magnetized such that magnetomotive force is oriented in the circumferential direction. Specifically, each of the permanent magnets 56 has the magnetic pole as N pole on the circumferential surface facing in the opposite direction to the first claw-shaped magnetic pole part 62-1 magnetized to the N pole. In addition, each of the permanent magnets 56 has the magnetic pole as S pole on the circumferential surface facing in the opposite direction to the second claw-shaped magnetic pole part 62-2 magnetized to the S pole. The permanent magnets 56 are configured as described above. The permanent magnets 56 may be incorporated into the rotor 24 after magnetization. Alternatively, the permanent magnets 56 may be magnetized after incorporation into the rotor 24.

The housing 26 is a case member that stores the stator 22 and the rotor 24. The housing 26 supports the rotation shaft 64 (that is, the rotor 24) via a bearing 69 in an axially rotatable manner. The housing 26 fixes the stator 22.

The brush device 28 has a slip ring 70 and brushes 72. The slip ring 70 is fixed to an axial end of the rotation shaft 64. The slip ring 70 has the function of supplying direct current to the field winding 52 of the rotor 24. The two brushes 72 is provided in a pair. The brushes 72 are held in a brush holder attached and fixed to the housing 26. The brushes 72 are disposed while being pressed to the rotation shaft 64 side such that the radially inner tips slide on the surface of the slip ring 70. The brushes 72 supply direct current to the field winding 52 via the slip ring 70.

The rectifier 30 is electrically connected to the armature winding 42 of the stator 22. The rectifier 30 is a device that rectifies alternating current generated by the armature winding 42 to direct current and outputs the same. The voltage adjuster 32 controls field current to be supplied to the field winding 52 to adjust the output voltage of the rotary electrical machine 20. The voltage adjuster 32 has the function of maintaining at substantially constant the output voltage varying according to electric load and power generation amount. The pulley 34 transfers the rotation of the vehicle engine to the rotor 24 of the rotary electrical machine 20. The pulley 34 is tightened and fixed to an axial end of the rotation shaft 64.

In the thus structured rotary electrical machine 20, direct current is supplied from the power source to the field winding 52 of the rotor 24 via the brush device 28. Accordingly, magnetic flux is generated by the passage of the current to penetrate the field winding 52 and flow through the boss part 58, the disc part 60, and the claw-shaped magnetic pole parts 62. This magnetic flux forms a magnetic circuit, for example, that flows from the boss part 58 of one pole core, the disc part 60, the first claw-shaped magnetic pole parts 62-1, the stator core 40, the second claw-shaped magnetic pole parts 62-2, the disc part 60 of the other pole core, the boss part 58, and the boss part 58 of the one pole core. The magnetic circuit generates counter electromotive force of the rotor 24.

The foregoing magnetic flux is guided to the first claw-shaped magnetic pole parts 62-1 and the second claw-shaped magnetic pole parts 62-2. As a result, the first claw-shaped magnetic pole parts 62-1 are magnetized to the N pole. The second claw-shaped magnetic pole parts 62-2 are magnetized to the S pole. While the claw-shaped magnetic pole parts 62 are magnetized in this manner, the direct current supplied from the power source is converted into three-phase alternating current and supplied to the armature winding 42. Accordingly, the rotor 24 rotates with respect to the stator 22. Therefore, in the configuration according to the present embodiment, the rotary electrical machine 20 can serve as an electric motor that rotationally drives the rotary electrical machine 20 by supply of power to the armature winding 42.

The rotor 24 of the rotary electrical machine 20 is rotated by transferring rotation torque of the vehicle engine to the rotation shaft 64 via the pulley 34. The rotation of the rotor 24 generates alternating electromotive force in the armature winding 42 by giving a rotating magnetic field to the armature winding 42 of the stator 22. The alternating electromotive force generated in the armature winding 42 is rectified to direct current through the rectifier 30 and then is supplied to the battery. Therefore, in the configuration according to the present embodiment, the rotary electrical machine 20 can serve as a power generator that charges the battery by generating electromotive force in the armature winding 42.

Next, characteristic components of the rotary electrical machine 20 in the present embodiment will be described.

In the present embodiment, the rotary electrical machine 20 includes the stator 22 and the rotor 24 that are opposed to each other with a predetermined air gap left therebetween in the radial direction. The rotor 24 has the cylindrical short-circuit member 54 on the outer peripheral side of the plurality of claw-shaped magnetic pole parts 62 disposed in the circumferential direction to cover the outer peripheral surfaces of the claw-shaped magnetic pole parts 62. The surface of the short-circuit member 54 facing in the opposite direction to the stator 22 is formed in the concave-convex shape.

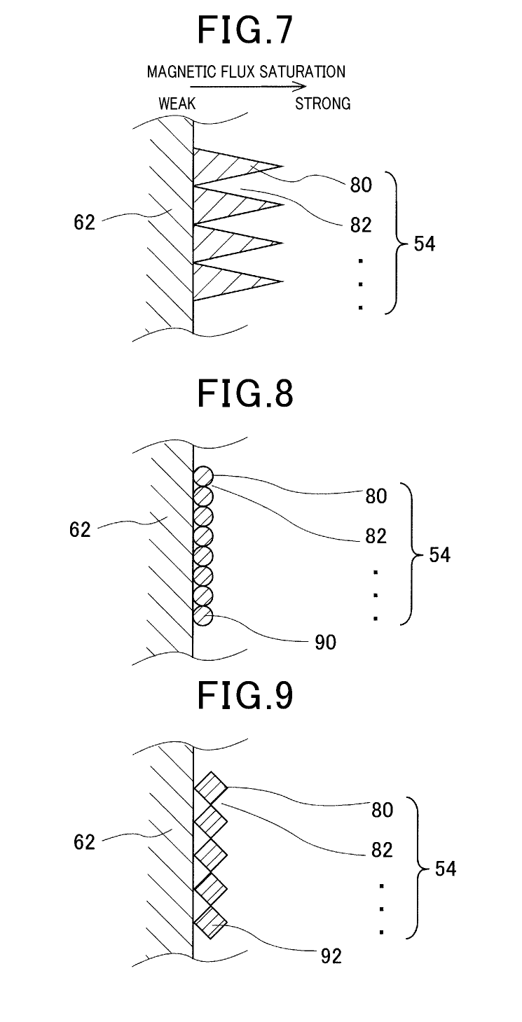

As illustrated in FIG. 7, the short-circuit member 54 has protrusion portions 80 that protrude along the radial direction and groove portions 82 that are recessed along the radial direction. That is, the protrusion portions 80 protrude toward the stator 22 side. The groove portions 82 are recessed toward the claw-shaped magnetic pole part 62 side. Both the protrusion portions 80 and the groove portions 82 are formed on the outer peripheral surface of the short-circuit member 54. The surface of the short-circuit member 54 facing in the opposite direction to the stator 22 (the outer peripheral surface of the short-circuit member 54) is formed in the concave-convex shape in which the protrusion portions 80 and the groove portions 82 are disposed alternately and continuously with each other.

The concave-convex shape of the short-circuit member 54 is formed such that the protrusion portions 80 and the groove portions 82 are disposed alternately and continuously along the axial direction. The short-circuit member 54 may be a stacked member in which sheet members are stacked along the axial direction. The short-circuit member 54 may be a stacked member in which a linear member or a belt-like member is extended in a spiral shape and stacked along the axial direction. Further, the short-circuit member 54 may be a cylindrical pipe-shaped member. When the short-circuit member 54 is a stacked member as described above, the concave-convex shape is configured such that the protrusion portions 80 are formed by the radially outer end portions of individual layers of the sheet members, linear member, or belt-like member and the groove portions 82 are formed by an air gap between each two layers. The concave-convex shape of the short-circuit member 54 can be formed in this manner.

It is generally known that, as the signal frequency becomes higher, electric current concentrates on the surface of a conductor, as skin effect. In the rotary electrical machine 20, a depth (skin depth) δ (mm) from the surface of the rotor 24 to a point where eddy current is generated in the short-circuit member 54 is expressed by equation (1) below. Eddy-current loss We [W] is expressed by equation (2) below. In the equations, μ represents magnetic permeability σ represents electric conductivity. f represents signal frequency. Ke represents eddy-current loss coefficient determined by the material for the short-circuit member 54 and the like. B represents magnetic flux density. a takes a value determined by the material for the short-circuit member 54 and the like, which is generally close to “2” by rounding.

δ=√(1/(π·μ·σ·f)) (1)

We=Ke·Ba^{α}·f ² (2)

Ke and α take respective values determined by the material for the short-circuit member 54 and the like as described above. Accordingly, to reduce the eddy-current loss We by the decided material, the magnetic flux density B needs to be reduced. The magnetic flux density B takes a value that increases up to the magnetic flux density of the material itself along with increase in the magnetic power of the rotary electrical machine 20. When the magnetic flux density B is high, the magnetic permeability μ decreases due to occurrence of magnetic flux saturation. However, the magnetic flux density B is a parameter proportional to the square of the eddy-current loss We with the square. Accordingly, decreasing the magnetic flux density B is effective in reducing the eddy-current loss We and achieving high efficiency.

The eddy current cannot pass between the protrusion portions 80. Accordingly, the skin depth δ of the protrusion portions 80 is small. The amount of eddy current is much small in places where the magnetic flux density B is small. Accordingly, the eddy-current loss We is small there. As described above, the short-circuit member 54 is formed in the concave-convex shape in which the protrusion portions 80 and the groove portions 82 are disposed alternately and continuously along the axial direction. In this concave-convex shape of the short-circuit member 54, magnetic flux saturation is more likely to occur with increasing proximity to the radial tips of the protrusion portions 80 of the short-circuit member 54. Accordingly, the magnetic flux density B is high and the eddy-current loss We is large there. On the other hand, the portion of the short-circuit member 54 close to the claw-shaped magnetic pole parts 62 and most of the claw-shaped magnetic pole parts 62 forming the pole core cause no magnetic flux saturation. Accordingly, the magnetic flux density B is low and the eddy-current loss We is small there.

As described above, the places where the eddy-current loss We is large are limited to the small protrusion portions 80 at the radial leading end of the short-circuit member 54. As a result, the short-circuit member 54 can reduce the eddy-current loss We as the entire member. That is, the rotary electrical machine 20 has the protrusion portions 80 provided such that magnetic flux concentrates on the surface of the short-circuit member 54 facing in the opposite direction to the stator 22. Accordingly, in the rotary electrical machine 20, the eddy-current loss We in the entire short-circuit member 54 can be reduced by decreasing or narrowing the places where the eddy-current loss We is large. According to the rotary electrical machine 20 of the present embodiment, the surface of the short-circuit member 54 is formed in the concave-convex shape to improve the effect of reducing the eddy-current loss We.

It is assumed that the short-circuit member 54 is formed from divided layers as described below. The divided layers are configured such that sheet members formed from flat sheets with an identical thickness are stacked in the axial direction. In this case, when the thickness of the divided layers is equal to or larger than (skin depth δ×2), eddy current loops are generated in each of the divided layers. In order not to generate eddy current loops in each of the divided layers, the divided layers need to be insulated with a thickness smaller than (skin depth δ×2). In contrast to this, in the rotary electrical machine 20 of the present embodiment, the surface of the radial leading end of the short-circuit member 54 is formed in the concave-convex shape with the protrusion portions 80 and the groove portions 82. Accordingly, in the rotary electrical machine 20, there is no need to uniformly decrease the thickness of the divided layers to prevent eddy current loops. In the rotary electrical machine 20, there is no need to provide the short-circuit member 54 with electrical insulating layers with a small pitch. In the rotary electrical machine 20, it is possible to suppress breakage of the electrical insulating layers or increase of loss resulting from insulation breakdown.

The eddy current is canceled out on the front side (opposed to the stator 22) of the rotor 24, where magnetic flux saturation is prone to occur, by the concave-convex shape of the short-circuit member 54. On the other hand, eddy current is small on the back side (the claw-shaped magnetic pole part 62 side) of the rotor 24, where magnetic flux saturation is less prone to occur. Accordingly, the short-circuit member 54 does not need to be provided with electrical insulation layers formed by separate members, air gaps, oxide films, or the like, not only on the front side of the rotor 24 but also on the back side of the rotor 24. As a result, the rotary electrical machine 20 can improve the effect of reducing eddy-current loss in the short-circuit member 54 without having to provide the short-circuit member 54 with electrical insulation layers. If the short-circuit member 54 is provided with electrical insulating layers, the thickness of the divided layers where magnetic flux saturation would locally occur can be increased in the rotary electrical machine 20. Accordingly, the rotary electrical machine 20 makes it possible to reduce the man-hours in manufacture without the need to reduce the thickness of the members constituting the divided layers of the short-circuit member 54.

The cross section of the radial tip of each of the protrusion portions 80 taken along the axial direction may be formed in a curved shape as illustrated in FIG. 8. For example, the short-circuit member 54 is formed from a stacked member as described below. The stacked member is structured such that predetermined members 90 such as sheet members or linear members are stacked in the axial direction. In this case, to form the curved shape of the protrusion portions 80, the predetermined members 90 constituting the short-circuit member 54 are formed by round wires with a circular cross section. The predetermined members 90 are in contact with the claw-shaped magnetic pole parts 62 in such a manner as to be electrically continuous with the claw-shaped magnetic pole parts 62 and cause a short-circuit. The predetermined members 90 in the individual layers are in contact with each other. The contact of the predetermined members 90 is point contact or similar contact in cross section.

In the structure in which the predetermined members 90 are formed from round wires, the protrusion portions 80 are formed by the circular surfaces of the predetermined member 90 in the individual layers that protrude to the radially outer side. In addition, the groove portions 82 are formed between the circular surfaces of two layers (two of the predetermined members 90) aligned in the axial direction. According to this configuration, as described above, it is possible to improve the effect of reducing eddy-current loss generated in the short-circuit member 54.

Each of the protrusion portions 80 may be formed such that the cross section of the radial tip taken along the axial direction has an angular shape as illustrated in FIGS. 9, 10, and 11. For example, the short-circuit member 54 is formed from a stacked member as described below. The stacked member is structured such that predetermined members 92, 94, 96 such as sheet members or linear members are stacked in the axial direction. In this case, to form the angular shape of the protrusion portions 80, the predetermined members 92, 94, 96 constituting the short-circuit member 54 are formed from angular wires with a cross section of a polygonal shape such as regular square, rectangle, or hexagon, for example. Specifically, the angular wires in the individual layers are obliquely disposed and stacked along the axial direction such that the angular portions of the angular wires protrude toward the stator 22. The predetermined members 92, 94, 96 are in contact with the claw-shaped magnetic pole parts 62 in such a manner as to be electrically continuous with the claw-shaped magnetic pole parts 62 and cause a short-circuit. The predetermined members 92, 94, 96 in the individual layers are in contact with each other. The contact of the predetermined members 92, 94, 96 is point contact, line contact, or similar contact in cross section.

In the structure in which the predetermined members 92, 94, 96 are formed from angular wires and the angular wires in the individual layers are obliquely disposed and stacked along the axial direction, the protrusion portions 80 are formed by the angular portions of the predetermined members 92, 94, 96 in the individual layers that protrude to the radially outer side. The groove portions 82 are formed between the angular portions of two layers aligned in the axial direction. In this configuration, as described above, it is possible to improve the effect of reducing the eddy-current loss generated in the short-circuit member 54.

Each of the protrusion portions 80 may be formed such that the cross section of the radial tip taken along the axial direction has a trapezoidal shape as illustrated in FIG. 12. Specifically, the cross section may be formed in a trapezoidal shape in which the upper tip face of a short side is positioned on the stator 22 side and the lower tip face of a long side is positioned on the claw-shaped magnetic pole part 62 side. For example, the short-circuit member 54 is formed from a stacked member as described below. The stacked member is structured such that predetermined members 98 such as sheet members or linear members are stacked in the axial direction. In this case, to form the protrusion portions 80 in the trapezoidal shape, the predetermined members 98 constituting the short-circuit member 54 are formed in a trapezoidal shape in which the cross section becomes narrower at the radial tip. The predetermined members 98 are in linear contact with the claw-shaped magnetic pole parts 62 in cross section in such a manner as to be electrically continuous with the claw-shaped magnetic pole parts 62 and cause a short-circuit. The predetermined members 98 in the individual layers are in point contact with each other in cross section. The contact of the predetermined members 98 may be similar to any of the foregoing contacts.

In the structure in which the predetermined members 98 are formed in a trapezoidal shape, the protrusion portions 80 are formed by the upper tip faces of the trapezoids of the predetermined members 98 in the individual layers. In addition, the groove portions 82 are formed between the upper tip faces of two layers aligned in the axial direction (between the side surfaces of trapezoids facing each other). In this configuration, as described above, it is possible to improve the effect of reducing eddy-current loss in the short-circuit member 54.

In the rotary electrical machine 20, the surface of the short-circuit member 54 opposed to the stator 22 is formed in the concave-convex shape in which the protrusion portions 80 and the groove portions 82 are disposed alternately and continuously with each other. The short-circuit member 54 is disposed on the front side of the rotor 24. That is, the short-circuit member 54 is disposed in a region where magnetic flux is most exchanged in the rotor 24 (magnetic flux is concentrated). The short-circuit member 54 ensures a heat dissipation area and exerts high cooling performance as compared to a short circuit member without a concave-convex shape.

To supply alternating-current power from the direct-current power source to the armature winding 42 of the stator 22, it is necessary to switch an MOS transistor or the like included in an inverter circuit. For example, the armature winding 42 is a three-phase wire. In this case, the timing for switching among U phase, V phase, and W phase may deviate from the desired timing. In the event of such a timing deviation, an axial potential difference occurs in the stator 22. Then, the potential difference results in electric current from the stator 22 to the rotor 24 via the housing 26 and the bearing 69. When this conduction current flows, electrolytic corrosion occurs in the bearing 69. This may lead to reduction in the life of the bearing 69.

In contrast to this, in the rotary electrical machine 20 of the present embodiment, the short-circuit member 54 or the predetermined members 90, 92, 94, 96, 98 constituting the short-circuit member 54 are in contact with the claw-shaped magnetic pole parts 62 and are electrically continuous with the claw-shaped magnetic pole parts 62. In the rotary electrical machine 20, when the short-circuit member 54 is not provided with electric insulation layers, the short-circuit member 54 is prone to cause eddy current. However, a potential difference is generated by the eddy current in the rotor 24. Accordingly, the potential of the rotor 24 rises as compared to the case where the eddy current is small or no eddy current is generated. As a result, the potential difference between the rotor 24 and the stator 22 decreases. Therefore, in the rotary electrical machine 20, it is possible to decrease conductive current from the stator 22 to the rotor 24 via the bearing 69 even if there occurs a deviation of timing for switching for supplying electric power to the armature winding 42 and there is generated large eddy current. The rotary electrical machine 20 can suppress decrease in the life of the bearing 69 caused by electrolytic corrosion.

As seen from the foregoing descriptions, the rotary electrical machine 20 of the present embodiment includes the stator 22 and the rotor 24. The stator 22 has the stator core 40 and the armature winding 42 wound on the stator core 40. The rotor 24 has the field core 50, the field winding 52, and the cylindrical short-circuit member 54, and is radially opposed to the inner peripheral side of the stator 22. The field core 50 has the cylindrical boss part 58 and the plurality of claw-shaped magnetic pole parts 62 that are disposed on the outer peripheral side of the boss part 58 and in which the magnetic poles of different polarities are alternately formed in the circumferential direction. The field winding 52 is wound on the outer peripheral side of the boss part 58. The short-circuit member 54 is disposed on the outer peripheral side of the claw-shaped magnetic pole parts 62 to cover the outer peripheral surfaces of the claw-shaped magnetic pole parts 62 and connect together magnetically the claw-shaped magnetic pole parts 62 adjacent to each other in the circumferential direction. The surface of the short-circuit member 54 opposed to the stator 22 is formed in the concave-convex shape in which the protrusion portions 80 protruding along the radial direction and the groove portions 82 recessed in the radial direction are disposed alternately and continuously with each other.

According to this configuration, in the rotary electrical machine 20, the surface of the short-circuit member 54 opposed to the stator 22 is formed in the concave-convex shape in which the protrusion portions 80 and the groove portions 82 are disposed alternately and continuously in the radial direction. In the rotary electrical machine 20, the concave-convex shape of the short-circuit member 54 concentrates magnetic flux on the protrusion portions 80 to prevent the occurrence of magnetic flux saturation in the other portions. Accordingly, in the rotary electrical machine 20, the magnetic flux density decreases to reduce eddy-current loss. Therefore, in the rotary electrical machine 20, forming the surface of the short-circuit member 54 in the concave-convex shape makes it possible to improve the effect of reducing eddy-current loss.

In the rotary electrical machine 20, each of the protrusion portions 80 may be formed such that the cross section of the radial tip has a curved shape or an angular shape. Alternatively, each of the protrusion portions 80 may be formed such that the cross section of the radial tip has a trapezoidal shape in which the upper tip face of the short side is positioned on the stator 22 side and the lower tip face of the long side is positioned on the claw-shaped magnetic pole part 62 side. According to these configurations, the rotary electrical machine 20 can have the concave-convex shape on the surface of the short-circuit member 54.

In the rotary electrical machine 20, the short-circuit member 54 and the claw-shaped magnetic pole parts 62 are electrically continuous with each other. According to this configuration, even when large eddy current is generated in the short-circuit member 54, the rotary electrical machine 20 can raise the potential of the rotor 24 by the eddy current. Accordingly, the rotary electrical machine 20 can reduce current conducted from the stator 22 to the rotor 24 via the bearing 69 that would be caused by a deviation of timing for switching to supply electric power to the armature winding 42. The rotary electrical machine 20 can suppress reduction in the life of the bearing 69 caused by electrolytic corrosion.

In the rotary electrical machine 20, the short-circuit member 54 may be a stacked member in which the predetermined members 90, 92, 94, 96, 98 are stacked along the axial direction. According to this configuration, the rotary electrical machine 20 allows easy formation of the concave-convex shape on the surface of the short-circuit member 54.

In the foregoing embodiment, the short-circuit member 54 of the rotor 24 is a cylindrical pipe-shaped member as an example. Alternatively, the short-circuit member 54 is a stacked member in which the predetermined members 90, 92, 94, 96, 98 are stacked along the axial direction as an example. The technique of the present disclosure is not limited to this. To enhance the cooling performance of the rotor 24, for example, the short-circuit member 54 is desirably formed in a spiral shape so that the coolant can be supplied during rotation of the rotor 24.

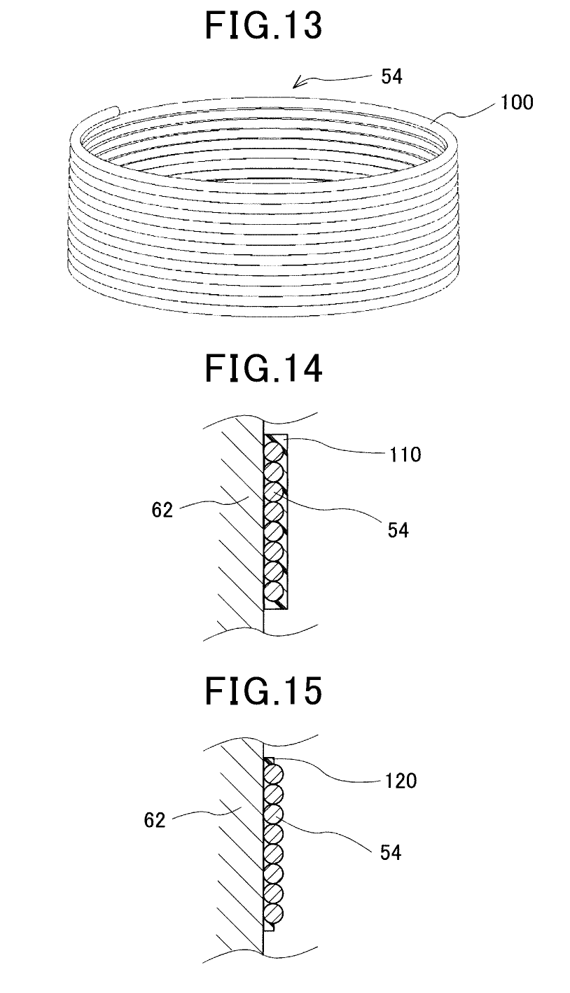

That is, the short-circuit member 54 may be a stacked member in which a linear member 100 is extended in a spiral shape and is stacked along the axial direction as illustrated in FIG. 13, for example. In this case, the protrusion portions 80 and the groove portions 82 are formed in a spiral shape and extend along the axial direction. Accordingly, in this modification example, during rotation of the rotor 24, the coolant can be fed from the first axial end side to the second axial end side of the short-circuit member 54. The rotary electrical machine 20 thus allows efficient cooling of the rotor 24 by the flow of the coolant to enhance the cooling performance of the rotor 24. In particular, in the rotary electrical machine 20, the cooling performance of the rotor 24 can be further enhanced by aligning three directions described below. Specifically, while the rotation direction of the rotor 24 is limited to one direction, the direction in which the rotation shaft 64 of the rotor 24 extends, the direction in which the coolant is fed out by the rotation of the rotor 24, and the direction in which the coolant is fed out by a guide vane, fan, pump, or the like are aligned with one another.

In the foregoing embodiment, the groove portion 82 between the protrusion portion 80 and the protrusion portion 80 in the short-circuit member 54 is an air gap and no resin or the like is charged between the short-circuit member 54 and the claw-shaped magnetic pole parts 62. The technique of the present disclosure is not limited to this. A resin may be charged into the groove portions 82. In addition, a resin may be charged between the short-circuit member 54 and the claw-shaped magnetic pole parts 62. Specifically, in the rotor 24, a resin 110 may be charged into both a clearance between the short-circuit member 54 and the claw-shaped magnetic pole parts 62 and the groove portions 82, as illustrated in FIG. 14, for example. The clearance between the short-circuit member 54 and the claw-shaped magnetic pole parts 62 into which the resin 110 is charged mainly includes a space surrounded by the short-circuit member 54 and the claw-shaped magnetic pole parts 62. This space is formed in the state in which there is ensured electrical continuity between the short-circuit member 54 and the claw-shaped magnetic pole parts 62.

The resin 110 is charged into both the clearance between the short-circuit member 54 and the claw-shaped magnetic pole parts 62 and the groove portions 82 to cover integrally all the layers stacked along the axial direction in the short-circuit member 54. The resin agent constituting the resin 110 may be a resin such as an epoxy resin or liquid crystal polymer with high heat conductivity, for example. According to the configuration of this modification example, the rotary electrical machine 20 can improve heat capacity by the provision of the resin as a heat conductor. Accordingly, the rotary electrical machine 20 can improve the heat resistance of the rotor 24. In addition, the rotary electrical machine 20 can sufficiently enhance the cooling performance of the rotor 24 even when the rotor 24 does not rotate or the rotor 24 rotates at a low speed.

In the example of the configuration described above, the resin 110 is charged in the groove portions 82 and between the short-circuit member 54 and the claw-shaped magnetic pole parts 62, but the present disclosure is not limited to this. For example, the resin 110 may be charged in at least either the clearance between the short-circuit member 54 and the claw-shaped magnetic pole parts 62 or the groove portions 82.

In the rotary electrical machine 20, the short-circuit member 54 exerts both the cooling effect produced by extending the linear member 100 in a spiral shape and forming the stacked member by stacking along the axial direction and the cooling effect produced by charging the resin 110. To this end, preferably, a resin 120 is charged into the clearance between the short-circuit member 54 and the claw-shaped magnetic pole parts 62 but is not charged into the groove portions 82 on the front side of the rotor 24 as illustrated in FIG. 15, for example. That is, the resin 120 is preferably charged into only the clearance between the short-circuit member 54 and the claw-shaped magnetic pole parts 62. According to the configuration of this modification example, the rotary electrical machine 20 can feed the coolant from the first axial end side to the second axial end side of the short-circuit member 54 during rotation of the rotor 24. The rotary electrical machine 20 can improve heat capacity by the provision of the resin 120.

The technique of the present disclosure is not limited to the foregoing embodiment or modification example. The rotary electrical machine 20 of the present disclosure can be modified in various manners without deviating from the gist of the present disclosure.

### REFERENCE SIGNS LIST

20 . . . Rotary electrical machine

22 . . . Stator

24 . . . Rotor

40 . . . Stator core

42 . . . Armature winding

50 . . . Field core

52 . . . Field winding

54 . . . Short-circuit member

58 . . . Boss part

62 . . . Claw-shaped magnetic pole part

80 . . . Protrusion portion

82 . . . Groove portion

90, 92, 94, 96, 98 . . . Predetermined member

100 . . . Linear member

110, 120 . . . Resin

1. A rotary electrical machine comprising:
a stator that has a stator core and an armature winding wound on the stator core; and
a rotor that has a field core with a cylindrical boss part and a plurality of magnetic pole parts that are disposed on an outer peripheral side of the boss part and in which magnetic poles of different polarities are alternately formed in the circumferential direction, a field winding that is wound on the outer peripheral side of the boss part, and a short-circuit member that is disposed on the outer peripheral sides of the magnetic pole parts to cover the outer peripheral surfaces of the magnetic pole parts and magnetically connects together the magnetic pole parts adjacent to each other in the circumferential direction, and is radially opposed to an inner peripheral side of the stator, wherein
a surface of the short-circuit member opposed to the stator is formed in a concave-convex shape in which protrusion portions protruding along the radial direction and groove portions recessed along the radial direction are disposed alternately and continuously with each other.

2. The rotary electrical machine according to claim 1, wherein each of the protrusion portions is formed such that the cross section of a radial tip has a curved shape or an angular shape.

3. The rotary electrical machine according to claim 1, wherein each of the protrusion portions is formed such that the cross section of the radial tip has a trapezoidal shape in which an upper tip face of a short side is positioned on the stator side and a lower tip face of a long side is positioned on the magnetic pole part side.

4. The rotary electrical machine according to claim 1, wherein the short-circuit member and the magnetic pole parts are electrically continuous with each other.

5. The rotary electrical machine according to claim 1 wherein a resin is charged in at least one of a clearance between the short-circuit member and the magnetic pole parts and the groove portions.

6. The rotary electrical machine according to claim 1 wherein the protrusion portions and the groove portions are formed in a spiral shape and extended along the axial direction.

7. The rotary electrical machine according to claim 1 wherein the short-circuit member is a stacked member in which predetermined members are stacked along the axial direction.
